(19) United States
(12) Patent Application Publication
(10) Pub. No.: US 2018/0147944 A1
(43) Pub. Date: May 31, 2018

(54) SUPERAAACHARGE

(71) Applicant: Henry Allen Perkins, Florissant, MO (US)

(72) Inventor: Henry Allen Perkins, Florissant, MO (US)

(21) Appl. No.: 15/361,406

(22) Filed: Nov. 26, 2016

(51) Int. Cl. B60L 11/18; H01M 2/10; H02J 50/12; H02J 7/02; H02J 7/00; H02M 7/44; B60L 11/02

(52) U.S. Cl. CPC B60L 11/1811; H01M 2/1077; H02J 50/12; H02J 7/025; H02J 7/0027; B60Y 2400/61; B60L 11/02; B60Y 2400/112; B60Y 2400/60; B60Y 2400/42; H02M 7/44

(57) ABSTRACT

The vehicle based electromechanical process and apparatus providing for the generation of electrical energy from many vehicles, and for its intermediate storage into a cluster of storage batteries that are onboard each vehicle and finally for multiple events for each vehicle of the transfer of the stored energy to the nation's electrical grid. It is the integrated utilization of three components: generation, storage and grid collection. The rationale is that in the U.S., billions of transportation miles are routinely logged each day by more than a quarter billion vehicles and trains, presenting the potential to produce large amounts of electricity, and with the production of electricity, many major related benefits, and some of them ecological. Simply stated, the energy that will be used anyway in the operation of vehicles, will also be used indirectly to create large quantities of electrical energy directed into the nation's electrical grid.

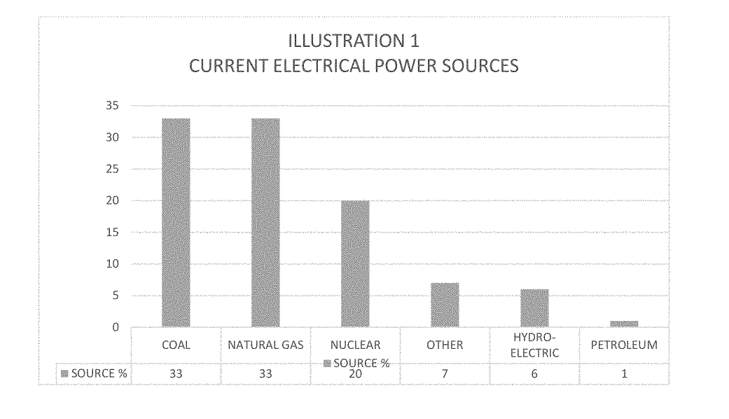

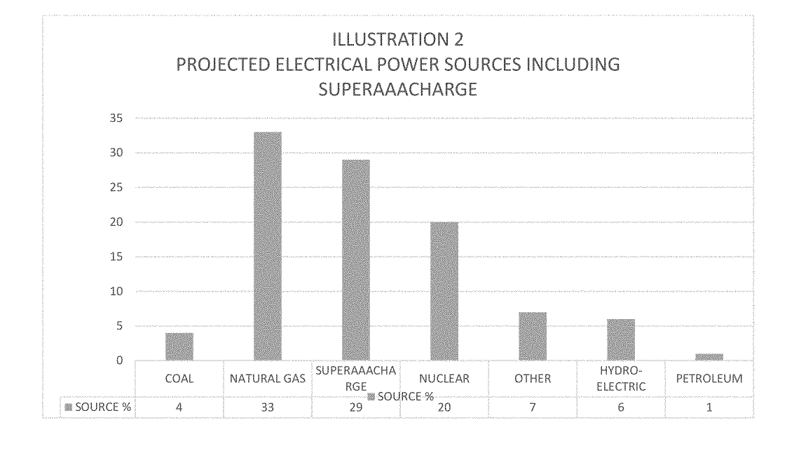

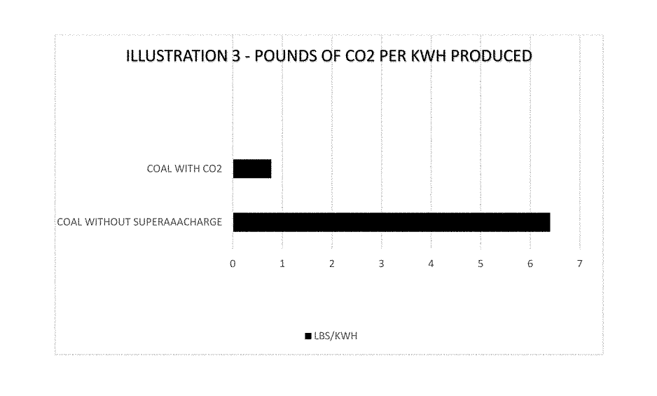

In the United States there are approximately 190 million passenger cars, 20,000 railroad trains and 130 million trucks of eight varying classes or sizes.

The U.S. Energy Information Administration (EIA) at hhtps://www.eia.gov is being used as the primary reference for energy statistics stated in this document for energy statistics.

The benchmark for electrical energy cost per kilowatt-hour (cost to produce from coal, according to EIA for the year 2015), is 3.24 cents or 0.0324 dollars (note that this is not the average consumer cost of $0.1268 per KWH). This unit cost of 3.24 cents for production of electrical energy will also serve as the price per kilowatt that will be paid or credited to clients that produce energy with this invention.

The basis for all projections of power produced is the equation:

power (P)=amperage(I)*Electromotive Force(E), that is P=I*E.

The minimum deployment of this invention will be for passenger vehicles with 4 or more battery cells as a cluster along with two or more additional alternators with high output (HO) of 300 amperes or greater and with storage battery voltage of 48 to 208 volts.

As the physical size or class of any vehicle increases the number of cells in a cluster, number of additional alternators and storage battery cluster voltage may increase.

The minimum quantity of power to be delivered during discharge of the battery cluster, in order to be cost effective, is 4 kwh for each battery cell, which is approximately 16 KWH from one battery cluster of 4 cells for each cycle and with 16 cycles a day.

One storage cycle will consist of the process of the alternator(s) completely charging the battery cluster followed by the transfer of energy from the fully charged cluster into the energy grid. Although 16 storage charge/discharge cycles is the desired number, the number may vary based on actual charge/discharge/transfer times.

Below are projections of the power to be produced and the associated dollar value for various sizes or classes of vehicles. The projections are based on full rollout and with 90% of vehicles nationwide utilizing this invention.

The number of onboard storage cells and alternators listed below for each vehicle class is the minimum quantity that will be onboard the vehicle during normal vehicle use for transport of humans or commodities.

The number of battery cells in a cluster for each vehicle class is the number of cells that can be stored on the vehicle and can be housed in unused areas under the hood, under the seats or in a rectangular fashion in the cargo area, such as with 10 rows of batteries along the length of 10 feet and 16 columns of batteries along the width of 8 feet in an area in a truck and where a false floor can be built to house and cover battery cells in one layer. Where batteries are housed in a rectangular fashion, the false floor will allow for the remaining cargo space to be available for conventional hauling.

Specific Estimates for Various Vehicle Types/Sizes.

Given 190 million passenger cars in the U.S. where each can carry 6 battery cell clusters, and will have three 300 ampere alternators, and each storage battery cell will provide 208 volts, there will be 31.2 KWH discharged from each battery cell, which is 187.2 kwh from each cluster cycle and with 16 cycles a day for a total of 2,995.2 KWH from one passenger car each day. There will be the accumulated daily quantity of 569.088 billion KWH transmitted into the energy grid from 190 million passenger cars.

The monetary value for a one day transmission of energy from one passenger car with a 6 battery cell cluster is $37.3248.

For the cumulative daily quantity transmitted energy nationwide from all such vehicles, the related daily monetary value will be $18,438,451,200.

Given 30 million (class 1 and 2) trucks in the U.S. where each can carry 30 cell clusters and six additional 300 ampere alternators, and each battery cell will provide 208 volts, will generate 12.480 KWH from each battery cell, which is 374.4 kwh from each cluster cycle with 16 cycles for a total of 5,990.4 KWH from one class 1 or 2 truck each day, there will be the accumulated daily quantity of 179.712 billion KWH transmitted into the energy grid from 30 million class 1 or 2 trucks.

The monetary value for a one day transmission of energy from one class 1 or 2 truck with a 30 cell cluster is $194.08896.

For the cumulative daily transmitted energy nationwide from all such vehicles, the related daily monetary value will be $5,822,668,800.

In addition to the class 1 and 2 trucks, given 30 million medium (class 3) trucks in the U.S. where each can carry 50 cell clusters and six additional 300 ampere alternators, and each battery cell will provide 208 volts, will generate 7.488 KWH from each battery cell, which is 374.400 kwh from each cluster cycle with 16 cycles for a total of 5,990.4 KWH from one class 3 truck each day, there will be the accumulated daily quantity of 179.712 billion KWH transmitted into the energy grid from 30 million class 3 trucks.

The monetary value for a one day transmission of energy from one class 3 truck with a 50 cell cluster is $194.088896.

For the cumulative daily transmitted energy nationwide from all such vehicles, the related daily monetary value will be $776,355,840.

In addition to the class 3 trucks, given 20 million large walk in (class 4) trucks in the U.S. where each can carry 80 cell clusters and ten additional 400 ampere alternators, and each battery cell will provide 208 volts, will generate 10.4 KWH from each battery cell, which is 832 kwh from each cluster cycle with 16 cycles for a total of 13,312 KWH each day, there will be the daily accumulated quantity of 266.240 billion KWH transmitted into the energy grid from 20 million trucks.

The monetary value for a one day transmission of energy from one class 4 truck with a 80 cell cluster is $431.3088.

For the cumulative daily transmitted energy nationwide from all such vehicles, the related daily monetary value will be $8,626,176,000.

In addition to the class 3 and class 4 trucks, given 20 million large (class 5) trucks in the U.S. where each can carry 160 cell clusters and ten additional 400 ampere alternators, and each battery cell will provide 208 volts, will generate 5.2 KWH from each battery cell, which is 832 kwh from each cluster cycle with 16 cycles for a total of 13,312 KWH each day, there will be the daily accumulated quantity of 266.240 billion KWH transmitted into the energy grid from 20 million trucks.

The monetary value for a one day transmission of energy from one class 5 truck with a 160 cell cluster is $431.3088.

For the cumulative daily transmitted energy nationwide from all such vehicles, the related daily monetary value will be $8,626,176,000.

In addition to the class 3, 4 and class 5 trucks, given 20 million large (class 6) trucks in the U.S. where each can carry 160 cell clusters and ten additional 400 ampere alternators, and each battery cell will provide 208 volts, will generate 5.2 KWH from each battery cell, which is 832 kwh from each cluster cycle with 16 cycles for a total of 13,312 KWH each day, there will be the daily accumulated quantity of 93.184 billion KWH transmitted into the energy grid from 20 million trucks.

The monetary value for a one day transmission of energy from one class 6 truck with a 160 cell cluster is $431.3088.

For the cumulative daily transmitted energy nationwide from all such vehicles, the related daily monetary value will be $8,626,176,000.

In addition to the class 3,4,5 and class 6 trucks, given 20 million large (class 7) trucks in the U.S. where each can carry 200 cell clusters and 20 additional 400 ampere alternators, and each battery cell will provide 208 volts, will generate 8.320 KWH from each battery cell, which is 1,664 kwh from each cluster cycle with 16 cycles for a total of 26,624 KWH from one class 7 truck each day, there will be the daily accumulated quantity of 186.368 billion KWH transmitted into the energy grid from 20 million trucks.

The monetary value for a one day transmission of energy from one class 7 truck with a 200 cell cluster is $862.61.

For the cumulative daily transmitted energy nationwide from all such vehicles, the related daily monetary value will be $6,038,323,200.

In addition to the class 3, 4. 5, 6 and class 7 trucks, given 5.5 million large (class 8/tractor-trailer) trucks in the U.S. where each can carry 200 cell clusters and 20 additional 400 ampere alternators, and each battery cell will provide 208 volts, will generate 8.320 KWH from each battery cell, which is 1,664 kwh from each cluster cycle with 16 cycles for a total of 26,624 KWH from one class 8 truck each day, there will be the daily accumulated quantity of 146,432,000,000 billion KWH transmitted into the energy grid from 5.5 million trucks.

The monetary value for a one day transmission of energy from one class 8 truck with a 200 cell cluster is $862.61.

For the cumulative daily transmitted energy nationwide from all such vehicles, the related daily monetary value will be $4,744,396,800.

In addition to the various classes of trucks, given 20 thousand heavy rail trains in the U.S. where each can carry 30 additional cars with a 800 cell cluster in each added car for a total of 24,000 cells for one train and each added car will have one hundred 400 amp alternators in operation along with battery voltage of 208 volts and generate 10.4 KWH from each battery cell and 8,320 KWH in each car cluster and 249,600 KWH during each cycle for 30 car clusters with at least 40 cycles a day for a total of 9.984 million KWH each day, there will the daily accumulated quantity of 199.680 billion kilowatt-hours transmitted into the energy grid from 20 thousand heavy rail trains.

The monetary value for a one day transmission of energy from one rail train with a combined 24,000 cell cluster is $323,481.60.

For the cumulative daily energy nationwide from all such vehicles, the related daily monetary value will be $6,469,632,000.

There are other vehicles in addition to these cars, trucks and trains that may also serve as host vehicles for SUPERAAACHARGE such as 500,000 school buses, a large number of light rail trains and 9 million recreation vehicles. These other vehicles as well as “SPECIALTY” vehicles other than train and passenger, are not being included in table 1—projections of energy production.

These other vehicles as well as various classes of trucks can also have trailers loaded with storage battery clusters attached to the vehicle along with several alternators propelled by the movement of the trailer wheels on the roadway.

For all trucks and rail vehicles, the “one way” rule will result in increased revenues from deployment of this invention. The “one way” rule stipulates that any vehicle that hauls freight but then makes the return trip empty, can on the return trip, maximize the SUPERAAACHARGE configuration of alternators and storage cells utilizing the freed up cargo space, and thereby generate much more electrical energy into the power grid and generate more revenue from the energy that is sold.

The anticipation is that if these additional vehicles and trailers were also included in the list of energy production the resulting percentage would approach or exceed the 33% of both coal and natural gas.

Specialty Vehicle

In addition to the various class trucks and rail, there will be a special application of SUPERAAACHARGE with RAIL transport and this will be a departure from the fundamental basis for SUPERAAACHARGE which is that energy expended for the primary purpose of transport will also be harnessed for the secondary production of electrical energy. The departure will be that energy will be intentionally expended for the primary purpose of propelling rail trains or other vehicles in the production of electrical energy. Specifically there can be up to 2,000 “SPECIAL” trains operated daily, with 250 rail cars or more for each, where the only cargo will be SUPERAACHARGE storage batteries, along with a 800 cell battery cluster in each rail car for a total of at least 200,000 cells for one train and each rail car will have two hundred 400 amp alternators in operation along with battery voltage of 208 volts and generate 20.8 KWH for each battery cell and 16,640 KWH in each rail car cluster and 4.160 million KWH during each cycle for one rail train with 250 rail car clusters with at least 40 cycles a day for a total of 166.4 million KWH each day, there will the daily accumulated quantity of 199.680 billion kilowatt-hours transmitted into the energy grid from 1,200 specialty heavy rail trains. (above calculation): 20.8 KWH*800 cells=16,640 KWH for one carcluster *250 cars in one train=4,160,100 KWH in one train*40 cycles per day=166,400,000 KWH for one train daily with all 40 cycles*2,200 specialty trains=332.800 billion KWH.

The monetary value for a one day transmission of energy from one rail train with a 200,000 cell cluster is $5,391,360

For the cumulative daily energy nationwide from all such vehicles, the related daily monetary value will be $10,782,720,000.

Given that the specialty trains will operate only to generate electricity they will operate at least 20 hours each day and there will be at least 40 charge/discharge cycles for the battery clusters on these trains, ultimately to be discharged via a hard-wired connection of the train rail to the energy grid.

Most other vehicle types or classes may also be deployed for maximum use of storage battery cells as described for the special deployment case of rails above. For any specialty vehicle application the maximum number of storage batteries that can be housed in the vehicle and the maximum number of alternators that can be operated from the vehicle motion or other propulsion, and the proper voltage level for the batteries, will be employed in the operation of a specialty vehicle.

As a notable point concerning passenger vehicles utilized for SUPERAAACHARGE deployment in either the “SPECIALTY” state which maximizes energy production for any specially deployed vehicle, or during normal use of the vehicle, the deployment will lend itself greatly for the so-called “TRUE” automobile—that is for any vehicle than can operate for extended timeframes without any human operation. Such human-less vehicles have been proven feasible and exist operationally as of the year 2016, but the purchase cost is currently prohibitive. SUPERAAACHARGE, when deployed on one of these true-automobiles, will provide daily income from electrical energy production. Such income from the deployment of SUPERAAACHARGE in one “true” human-less automobile that can operate for more than 32 cycles daily would generate twice the revenue from a conventional passenger car, with which to defray the cost of a true-automobile.

EIA monthly total electric megawatts generated in the U.S. in May, 2016 was 300,000 thousand megawatts or 300,000 gigawatts. That translates to an average daily quantity of 10,000 thousand megawatts or 10,000 gigawatts.

TABLE 1
projections for SUPERAAACHARGE energy production

| Vehicle class | cumulative total energy transmitted (KWH) | |
|---|---|---|
| Passenger | 569.088 | billion |
| 1 and 2 | 179.712 | billion |
| 3 | 179.712 | billion |
| 4 | 266.240 | billion |
| 5 | 266.240 | billion |
| 6 | 266.240 | billion |
| 7 | 532.480 | billion |
| 8 | 146.432 | billion |
| Train | 199.680 | billion |
| Special train | 332.800 | billion |
| SPECIAL PASSENGER | 33.280 | billion |
| Total | 2.971904 | trillion KWH |

(the projected total daily energy generated from this invention will be 2.971904 trillion KWH which is 29.71904% of the actual average daily electrical energy produced in the U.S. for May 2016 (as shown in EIA published information), which was 10,000 gigawatts.)

EIA lists the sources for electrical energy in the U.S. for the year 2015

Based on the list (below), electrical energy produced from this invention at 29.71904% would surpass nuclear as the third greatest source for electrical energy production. This projected percentage from this invention is based on full rollout and with 90% of vehicles utilizing this invention.

1—Natural gas 33%

2—Coal 33%

(PROJECTED # 3 producer is this invention 29.71904%)

3—Nuclear 20%%

4—Other non-Renewables 7%

5—Hydroelectric 6%

6—Petroleum 1%

Costs
1. All development, installation and maintenance costs will be assigned to vehicle owners using a prorated factor which is the proportion as shown above of that vehicle class kwh to the total production from this invention. All development and installation costs will be underwritten and paid by federal and state governmental entities as a loan to vehicle owners that participate in this invention and to be repaid in monthly installments from a portion of the produced energy revenues.
2. The storage cell cost will be determined with a certain cost for each cell unit and with multiple cells as a storage cluster per host vehicle. Clusters with many more battery cells will be employed as the vehicle size increases. The multifaceted goal with claim 9 will be to minimize the cost of Kilowatt-hours per kg and maximize the kwh produced per kg and have fast charge/discharge cycles. The storage batteries will provide voltage of 48 volts or more.
3. Alternator(s) will be installed with the capacity to generate 300 amperes or more. The desired cost for the dedicated alternator will be determined.
4. The Highly Resonant Wireless Power Transfer transmitter will be manufactured and installed at a certain cost.
5. There will be the projected cost per vehicle for the physical wiring onboard the vehicle of the storage cells, alternators and the transmitter.
6. There will be a fixed cost for the reinforcement of the vehicle suspension, if required, to allow for the increased weight from the battery cells.
7. There will be a cost for installing the roadside receiver spans.
8. There will be a cost for installing the hard-wired connection for rail implementations.
9. There will be a cost for the onboard computerized accounting function.
10. There will be a cost for the external central control function that will govern the recording and monetary payment for all power that is transferred into the grid.
11. There will be a cost for the onboard boom antenna control function.
12. There will be a cost for the onboard signal detection to indicate the existence of a receiver.
13. There will be a cost for the external signal apparatus which will send the indication of the presence of a receiver.
14. For all vehicles that serve as host for this invention, there will be an implicit and unrecorded cost based on the residual performance loss of any vehicle due to the additional expended energy in propelling the alternators and additional performance loss due to the weight increase of alternators and storage batteries.
15. All development, installation and maintenance costs will be assigned to vehicle owners using a prorated factor which is the proportion as shown above of that vehicle class kwh to the total production from this invention. All development and installation costs will be underwritten and paid by federal and state governmental entities as a loan to vehicle owners that participate in this invention and to be repaid in monthly installments from a portion of the produced energy revenues.
16. There will be a cost for installing the roadside receiver spans.
17. There will be a cost for installing the hard-wired connection for rail implementations.
18. There will be a cost for the onboard computerized accounting function.
19. There will be a cost for the external central control function that will govern the recording and monetary payment for all power that is transferred into the grid.
20. There will be a cost for the onboard boom antenna control function.
21. There will be a cost for the onboard signal detection to indicate the existence of a receiver.
22. There will be a cost for the external signal apparatus which will send the indication of the presence of a receiver.

### BACKGROUND OF THE INVENTION

The focus for the utilization of energy produced onboard any vehicle has historically been for the powering of the vehicle, whether it be an electric vehicle or a hybrid vehicle.

The related focus of Highly Resonant Wireless Power Transfer has been the same as for energy produced onboard a vehicle.

There has been some focus in harnessing power generated from wind or solar sources to be introduced into the power grid but there has been no activity in harnessing the huge numbers of moving vehicles in order to produce power into the power grid.

This invention has as its focus to harness the large number of vehicles, exceeding 250 million in number, and to transfer the energy produced by the motion of each vehicle into the electric power grid, with the cumulative quantity of energy being transferred to approach 29% of the daily electrical power produced in the U.S.

This invention has been made feasible by the breakthroughs in nano-technology that provides for storage batteries which combine the characteristics of fast charge, fast discharge and large storage capacity.

### BRIEF DESCRIPTION OF THE SEVERAL VIEWS OF THE DRAWING

ILLUSTRATION 1—CURRENT ELECTRICAL POWER SOURCES

ILLUSTRATION 2—PROJECTED ELECTRICAL POWER SOURCES INCLUDING THIS INVENTION

ILLUSTRATION 3—POUNDS OF CO2 PER KILOWATT-HOUR PRODUCED

### OTHER REFERENCES CITED

WiTricity Corporation (www.witricity.com) Vendor for Highly Resonant Wireless Power Transfer (HRWPT)

East Penn Manufacturing Company (www.eastpennmanufacturing.com) manufacturer/Vendor for Ultrabattery® storage battery

The claims are:

1. The invention is the vehicle based electromechanical process and supporting apparatus providing for the generation of electrical energy from many vehicles, and for its intermediate storage into a cluster of storage batteries that are onboard each vehicle and finally for multiple events for each vehicle of the transfer of the stored energy to the nation's electrical grid. It is the integrated utilization of three components: generation, storage and grid collection. The rationale is that in the U.S., billions of transportation miles are routinely logged each day by more than a quarter billion vehicles and trains, presenting the potential to produce large amounts of electricity, and with the production of electricity, many major related benefits, and some of them ecological. Simply stated, the energy that will be used anyway in the operation of vehicles, will also be used indirectly to create large quantities of electrical energy directed into the nation's electrical grid.

2. Claim 1 has the potential to produce electrical energy daily in quantities that will approach or surpass 20 percent of the current daily electrical energy produced in the United States.

3. Implementation of claim 1, financed by government subsidies, will provide the means for vehicle owners, with meager monetary resources at their disposals, to receive a considerable amount of monetary income from electrical energy production, while at the same time, repaying the government subsidies.

4. Claim 1 will result in the reduction in the use of coal, natural gas or other fuel sources that would have been used in producing similar quantities of electrical energy.

5. Claim 4 will result in a reduction in CO2 emitted into the environment.

6. Claim 4 will result in a reduction in other greenhouse gases emitted into the environment.

7. Full utilization of claim 1 will result in job creation in large numbers and in many work skill areas including:
Manufacture, distribution, installation and maintenance of battery clusters Manufacture, distribution, installation and maintenance of alternators Design, development, coding and installation and maintenance of computerized onboard accounting modules
Manufacture, installation and maintenance of HRWPT transmitters and receivers
Manufacture, installation and maintenance of boom antennas
Installation of Hard wired connections to the power grid
Advertising and promotion of this invention

8. The first component of claim 1 is the energy generation component, which consists of one or more additional onboard dedicated alternator(s) which will generate the ampere-hours to be stored. The existing vehicle alternator and battery (if any) will continue to supply energy for all conventional automobile electrical needs while this one or more dedicated alternator(s) will be installed in the host vehicle for exclusive use in generating energy. The host vehicle such as an automobile or train will propel this component to generate electrical energy. The alternators used for claim 1 will employ an automatic clutch that will disengage the alternator when the storage batteries are full and engage the alternators when the storage batteries can accept ampere-hours from the alternators.

9. The second component of claim 1 is the storage component which consists of a cluster of one or more battery cells which will be deployed in an automobile or truck or potentially any moving apparatus such as a railroad train. Each of the cluster battery cells will be wired in parallel with this dedicated host vehicle alternator(s). The storage battery cluster will be used solely for the accumulation of generated electrical energy from claim 8 and for the discharging of it into the electrical power grid and will not be used for any automobile operation needs.

10. As a vendor/supplier for claim 9, the East Penn Manufacturing Company currently manufactures a storage battery, the ULTRABATTERY®, which has characteristics that are a close fit to the characteristics required of a storage battery for claim 1 and claim 9. The characteristics include fast charge time, fast discharge time and relatively high energy storage capacity.

11. The third component of claim 1 is the collector component which will deliver stored electrical energy from claim 9 to the electrical energy grid.

12. Claim 11 will be in one of two forms: Hard wired connection or Wireless Highly Resonant Energy Transfer (HRWPT).

13. For claim 9 and with any of the two collector forms of claim 12, all electrical energy will have been stored in the battery cluster as in claim 9 as direct current (DC) but will be converted to alternating current (AC) just prior to transfer from the vehicle to the power grid via claim 12.

14. The first form of claim 12 and claim 13, the hard-wired form will consist of a hard-wired connection from the storage battery cluster to the electrical grid. This method will be employed primarily for the rail vehicle implementation of claim 1 with a hard wire connection from the train rail, utilizing a “hot” rail, to the energy grid.

15. The second form of claim 12 and claim 13, which will be used primarily for automobiles and trucks, is the Highly Resonant Wireless Power Transfer (HRWPT). HRWPT will provide 90% efficiency in power transfer, meaning that 10% or less of the power being transferred is lost during the transfer process.

16. The WiTricity Company is a representative vendor of HRWPT to be used in claim 15.

17. Claims 15 and 16 involves HRWPT, which consists of a transmitter and a receiver.

18. Claim 17 will have a transmitter onboard the vehicle which will transfer energy from claim 9 to the receiver which is stationary and external to the vehicle. The onboard transmitter will convert the energy stored in claim 9 and claim 13 from DC to AC and the transfer of energy will commence with the magnetic flux and resonant frequency generated by the onboard transmitter.

19. Claim 17 will have an offboard receiver for wireless highly resonant energy transfer that will consist of a long, coiled string of material extended along the roadway, that has the property to conduct electricity. The coiled wire will be installed along the roadway in similar fashion to existing power lines strung from poles and will be elevated above the roadbed to avoid any obstruction and will be hard wired to the power grid. The coiled wire will employ its resonant frequency synchronized to that of claim 18. The synchronized resonant frequency will allow for more efficient transfer of electrical energy from the transmitter to the receiver.

20. Claim 19 will emit a signal that is detected by the onboard vehicle receiver via BLUETOOTH° which will indicate that the receiver coil is present and the beginning and ending of the receiver span.

21. Claim 18 will reside at the top of a boom antenna that is automatically deployed from the vehicle so that the distance from the transmitter antenna and the receiver coil is less than 3 meters. The boom antenna will be adjustable for angle and direction, all controlled automatically, in order to provide the proper alignment and distance between the transmitter and the receiver.

22. Claim 17 will be automatically invoked and energy transfer automatically executed when the environment is such that (1) the claim 9 has reached a threshold quantity of energy and (2) a signal from the receiver coil has been detected indicating that a wireless receiver span is present. When the environment is conducive to energy transfer, the energy from the battery cluster is transmitted from the storage batteries through the antenna and a magnetic flux, created by the transmitted energy will in turn induce energy in the receiver coil. The energy transmission will continue as the vehicle proceeds along the roadside until the storage batteries have been discharged, along with the related energy having been induced to the receiver coil and subsequently to the electric energy grid.

23. Currently HRWPT exists in the U.S. with one component consisting of a wired circuit that is imbedded under the road surface and that transmits electrical power from the imbedded circuit to a moving vehicle that is equipped with a receiver that will receive the energy transmitted by the HRWPT from under the roadbed. It is possible that the existing HRWPT circuits may also be employed for claim 1 and claim 15, but in the opposite direction as a receiver and not as a transmitter, with power being transmitted from the moving vehicle to the imbedded circuit and on to the power grid, however the primary method for claim 15 will be from the vehicle to the receiver coil consisting of a long span of a wired circuit, elevated and extended along the roadway, rather than using imbedded roadway circuits, due to Increased installation and maintenance costs for imbedded circuits. The elevated coiled wire span will preferably be placed in the median of any roadway rather than have two strings of wire on both sides of the road. Having the span placed in the median will allow one span of receiver wire to serve in both traffic directions. An additional design option for the coiled wire along the roadway is to have it as a span overhead the traffic and suspended in such a way so all lanes of traffic can transmit power to the electrical grid.

24. An onboard computerized accounting/control function will be a feature of claim 11 to capture all accounting data relevant to the power transfer.

25. Claim 24 will also have the computerized control function of claim 21. This function will be able via BLUETOOTH® to detect a signal indicating both the beginning and end of each receiver coil span and deploy claim 21, in order to execute the actual wireless power transfer.

26. Claim 24 will have an onboard computerized accounting function to record all relevant data (quantity of power transmitted in Kilowatt-hours, the prevailing price per KWH of power, vehicle owner information, bank accounting information), for the energy transfer from the collector to the grid. The computerized accounting feature will send the recorded data via BLUTOOTH® to a central accounting control or financial bank for subsequent monetary credit to be given to the account of the client that owns the vehicle. The central accounting control will also send information to the electric power company to log the quantity of power that has been transferred to the power grid.

27. The physical aspects of claim 1, which are claim 8, claim 9, claim 18, claim 21 and claim 24, that will reside on the vehicle will be retrofitted into all vehicles that will participate in the energy generation effort.

28. A vehicle for claim 1 will produce energy in increased magnitudes as the class or size of the vehicle increases to be able to host an increased number of claim 8 and claim 9.

29. One cycle will consist of the process of claim 8 completely charging claim 9, followed by the discharge of claim 9 with all discharged power being transferred into the electrical power grid.

30. Claim 14 will be employed for any rail/light rail application of claim 1. The energy transfer will be accomplished by one or more hard wire connections from the rail cars battery clusters to the specific span of rail in the rail bed that has the capability of conducting electricity into the electrical energy grid. Multiple energy transfer claim 29 may take place during one train trip and any energy transfer process will be initiated when the stored energy quantity reaches the maximum for the train battery cluster and when a span of rail that is hard-wired to the power grid is present (hot rail). A signal sent via BLUETOOTH® will indicate both the beginning and end of each span of a hot rail. The train may remain in motion during energy transfer. The energy transfer will be accomplished in such a fashion that the rail will conduct electricity from claim 9 into the energy grid. Upon completion of the discharge process where claim 9 has been drained, claim 26 will be employed to record the transfer.

31. For claim 11 or claim 12 the charge/discharge process will take place:
a. When there is not a claim 14 or claim 19 present, claim 8 will charge claim 9 until claim 9 is full then when claim 9 is full claim 8 will disengage from the engine propulsion so there is no longer any drag from claim 8 operation.
b. When a claim 14 or claim 19 is present the claim 8 will generate and transfer ampere-hours to the power grid via claim 14 or claim 19, and claim 9 will simultaneously discharge and transfer power to the power grid via claim 14 or claim 19 until claim 9 has been completely discharged, and if claim 14 or claim 19 remains present after complete discharge of claim 9, claim 8 will continue to generate and transfer ampere-hours to the power grid via claim 14 or claim 19.
